(19) United States
(12) Patent Application Publication
(10) Pub. No.: US 2008/0316370 A1
(43) Pub. Date: Dec. 25, 2008

(54) Broadcasting receiver, broadcasting reception method and medium having broadcasting program recorded thereon

(75) Inventors: Masaya Tanigawa, Aichi (JP); Yoshikazu Yamagishi, Aichi (JP)

Correspondence Address: Yokoi & Co., U.S.A., Inc., 13700 Marina Pointe Drive #723, Marina Del Rey, CA, 90292, US

(73) Assignee: BUFFALO INC., Aichi (JP)

(21) Appl. No.: 12/214,405

(22) Filed: Jun. 18, 2008

(30) Foreign Application Priority Data
Jun. 19, 2007 (JP) JP2007-161455

(51) Int. Cl. H04N 5/44

(52) U.S. Cl. 348/725; 348/E05.096

(57) ABSTRACT

The present invention discloses a broadcasting receiver that receives broadcasting signals in terrestrial digital broadcasting and displays terrestrial digital broadcasting on a screen of a personal computer. The broadcasting receiver includes a recording unit that records a transport stream including the broadcasting signals as recorded data, assigns an elapsed time since recording initiation of the recorded data, and then records caption information contained in the transport stream corresponding to the recorded data as caption data; a search unit that searches, from the caption data, the caption information including a text row inputted via a user interface that receives a command from a user, and displays search results on the screen of the personal computer; and a reproduction unit that, when the caption information is alternatively selected from the search results via the user interface, starts reproducing the recorded data from the elapsed time corresponding to the selected caption information.

### CROSS-REFERENCES TO RELATED APPLICATIONS

The present application is related to the Japanese Patent Application No. 2007-161455, filed on Jun. 19, 2007, the entire disclosure of which is expressly incorporated by reference herein.

### BACKGROUND OF THE INVENTION

1. Field of the Invention

The present invention relates to a broadcasting receiver, a broadcasting reception method, and a medium having broadcasting reception program recorded thereon.

2. Description of Related Art

In terrestrial digital television broadcasting (digital terrestrial television broadcasting), a one-segment broadcasting frame is provided in addition to 12 segments necessary for the usual display, and the broadcasting of video, audio, and data using this one segment is usually called one-segment broadcasting. The information such as video, audio and data is transmitted using a transport stream (TS). One-segment broadcasting is received with a portable terminal or personal computer equipped with a tuner.

The data information includes caption information for displaying caption on a screen synchronously with video information or audio information. However, because new caption is successively displayed as the film progresses, for example, when the user wishes to record specific text information that has been displayed in the caption, it has to be done, while the user watches the screen, which is hardly convenient for the user.

In order to resolve this problem, JP2003-78889A discloses a caption processing device that analyzes caption information contained in a transport stream, successively stores the caption text, and displays the stored caption text as a list superimposed on the program video or usual caption based on remote control operations performed by a user. As a result, the user can display and review the text information displayed in the caption at all times on the television screen, without taking notes of each caption, and the load placed on the user by the information application process can be reduced.

On the other hand, such an approach can cause the following new problem. When the user searches a desired scene or a scene including a desired monolog or dialogue (caption text) from the video recorded data and reproduces the desired scene, it is necessary to actually reproduce the video recorded data to find the desired scene, which is inconvenient for the user. Further, with the technique described in JP2003-78889A, the desired caption text is saved and is only displayed as a list. Therefore, this technique cannot improve convenience for the user when the desired scene is searched from the video recorded data.

### BRIEF SUMMARY OF THE INVENTION

The present invention discloses to provide a broadcasting receiver that improves convenience for the user when the desired scene is reproduced from recorded data.

One aspect of the present invention provides a broadcasting receiver that receives broadcasting signals in terrestrial digital broadcasting and displays terrestrial digital broadcasting on a screen of a personal computer, the broadcasting receiver comprising:

a recording unit that records a transport stream comprising the broadcasting signals as recorded data, assigns an elapsed time since recording initiation of the recorded data, and then records caption information contained in the transport stream corresponding to the recorded data as caption data;

a search unit that searches, from the caption data, the caption information including a text row inputted via a user interface that receives a command from a user, and displays search results on the screen of the personal computer; and

a reproduction unit that, when the caption information is alternatively selected from the search results via the user interface, starts reproducing the recorded data from the elapsed time corresponding to the selected caption information.

An optional aspect of the present invention provides the broadcasting receiver as follows.

In the broadcasting receiver, the recording unit records a transport stream constituting the broadcasting signals as recorded data, assigns an elapsed time since the recording initiation of the recorded data, and then records caption information contained in the transport stream corresponding to the recorded data as caption data. Therefore, the caption data in the recorded data can be saved, for example in a storage device, in association with the elapsed time since the recording initiation of the recorded data. Further, the search unit searches from the caption data the caption information including a text row inputted via a user interface that receives a command from a user, and displays the search results on the screen of personal computer. Therefore, the user can search the desired scene in the recorded data by using any text row displayed in the caption, or search a scene where the text row has been used. Further, when the caption information is alternatively selected from the search results via the user interface, the reproduction unit starts reproducing the recorded data from the elapsed time corresponding to the selected caption information. Therefore, the user can reproduce the video recording information from a desired scene containing the desired text row.

Here, a configuration can be considered in which timing information for synchronizing with recorded information is originally included in the caption information contained in the transport stream and the recorded data are reproduced using this timing information. However, when timing information is used, it is necessary to search the corresponding timing information from the recorded data, and the reproduction processing of the recorded data can be delayed by this search time. Accordingly, because the bit rate in the terrestrial digital broadcasting is fixed, the reproduction start location during the reproduction of the recorded data is designated with pinpoint accuracy by using the elapsed time since the recording initiation of the recorded data.

An optional aspect of the present invention provides the broadcasting receiver wherein the recording unit can record a plurality of types of recorded data and records the caption data for each of the plurality of types of recorded data.

Another optional aspect of the present invention provides the broadcasting receiver wherein the search unit displays identification information contained in the recorded data corresponding to the caption information searched from the caption data, the elapsed time, and the caption information, as the search results.

Another optional aspect of the present invention provides the reproduction unit reproduces the recorded data selected from the search results from the elapsed time.

With such configurations, the caption data in each recorded data can be saved, for example, in a storage device in association with the elapsed time from the recording initiation of the respective recorded data for each of a plurality of types of recorded data. Further, the user can search the desired scene in a plurality of types of recorded data by using any text row displayed in the caption, or search a scene where the text row has been used. The user can also perform reproduction from a desired scene containing the desired text row in the corresponding video recording information.

Another aspect of the present invention provides a broadcasting reception method for receiving broadcasting signals in terrestrial digital broadcasting and displaying terrestrial digital broadcasting on a screen of a personal computer, the method comprising:

recording a transport stream comprising the broadcasting signals as recorded data;

assigning an elapsed time since recording initiation of the recorded data;

recording caption information contained in the transport stream corresponding to the recorded data as caption data;

searching the caption information including a text row inputted via a user interface that receives a command from a user from the caption data;

displaying search results on the screen of the personal computer; and

initiating reproduction of the recorded data from the elapsed time corresponding to the selected caption information when the caption information is alternatively selected from the search results via the user interface.

Thus, a procedure in which a database comprising caption information contained in the transport stream and the elapsed time from the record initiation of the recorded data is created, search from the database is performed, a user interface that displays the search results is provided, a caption containing any text row is displayed as a list, and the selection from the list of search results is performed in association with the reproduction of recorded data, thereby initiating reproduction from the corresponding scene is not necessarily limited to an actual apparatus and can also function as a method.

Further, the concept of the present invention is not limited to the above-described broadcasting receiver and includes a variety of forms thereof in which it is present as an independent device, or incorporated for use in a certain apparatus.

Another aspect of the present invention provides a computer readable recording medium having recorded therein a broadcasting reception program that causes a personal computer to execute a function of receiving broadcasting signals in terrestrial digital broadcasting and displaying terrestrial digital broadcasting on a screen of the personal computer, the personal computer caused to execute:

a recording function that records a transport stream comprising the broadcasting signals as recorded data, assigns an elapsed time since recording initiation of the recorded data, and then records caption information contained in the transport stream corresponding to the recorded data as caption data;

a search function that searches, from the caption data, the caption information including a text row inputted via a user interface that receives a command from a user, and displays search results on the screen of the personal computer; and

a reproduction function that, when the caption information is alternatively selected from the search results via the user interface, starts reproducing the recorded data from the elapsed time corresponding to the selected caption information.

The recording medium as referred to herein obviously includes the types of recording media that have been developed in recent years, such as magnetic recording medium and magnetooptical recording medium. Further, the magnetic medium also includes magnetic media at various copying stages thereof, such as primary copies and secondary copies. The present invention can be also used in the case where a communication circuit is employed as a method for supplying the program.

The present invention also includes the case in which it is realized partly as software and partly as hardware and also a mode in which the program part is recorded on a recording medium and appropriately read therefrom, as necessary, and executed.

When the present invention is implemented as software, it can be configured to be employed with hardware or an operating system, or it can be implemented separately therefrom. For example, when computations of various kinds are mentioned, where the implementation method thereof can include calling and processing a predetermined function in an operating system, such a function can be also inputted from hardware, instead of calling. Further, although the implementation is actually assumed to proceed via an operating system, it can be understood that in the process of recording a program on the recording medium and circulating thereof, the present invention can be implemented with the program alone.

When the present invention is implemented as software, the invention is obviously implemented not only as the medium where the program is recorded, but also as the program itself, and the program itself is also included in the present invention.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purpose of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

FIG. 1 is an exemplary illustration of a schematic drawing illustrating a broadcasting receiver.

FIG. 2 is an exemplary illustration of a schematic block-diagram illustrating the configuration of a broadcasting receiver.

FIG. 3 is an exemplary illustration of a drawing illustrating correspondence between PES packets and TS packet of a transport stream.

FIG. 4 is an exemplary illustration of an image of database recorded on the storage device.

FIG. 5 is an exemplary illustration of a drawing showing how a list of search results representing an example of search results is displayed in a subwindow.

FIG. 6 is an exemplary illustration of a flowchart illustrating a specific control operation for reproducing the desired scene from recorded data in the personal computer.

### DETAILED DESCRIPTION OF THE INVENTION

The detailed description set forth below in connection with the appended drawings is intended as description of presently preferred embodiments of the invention and is not intended to represent the only forms in which the present invention may be constructed and or utilized.

For purposes of illustration, programs and other executable program components are illustrated herein as discrete blocks, although it is recognized that such programs and components may reside at various times in different storage components, and are executed by the data processor(s) of the computers.

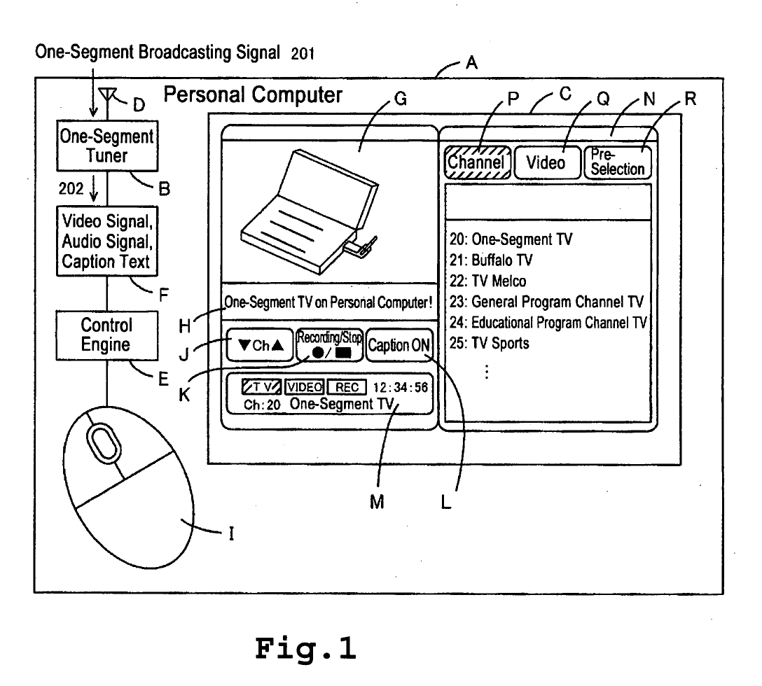

As shown in FIG. 1, a broadcasting receiver A of one embodiment of the present invention is configured by a personal computer. This personal computer receives a one-segment broadcasting signal 201 in terrestrial digital television broadcasting with an internal or external tuner B, and broadcasting can be displayed on a screen C of an internal (integrated) display of the personal computer or an external display. The terrestrial digital television broadcasting is terrestrial digital broadcasting (digital terrestrial broadcasting).

For example, with a control engine E based on internal software of the personal computer or tuner B, the one-segment broadcasting signal 201 inputted from an antenna D to the tuner B is converted into a transport stream 202, a video signal, an audio signal, and a caption text F are obtained from the transport stream 202, video G and sound that are synchronized are reproduced, and a caption text H synchronized with the video G and sound is displayed on the screen C. Such processing can employ a variety of well-known techniques.

On the screen C, a channel selection button J, a video recording/stop button K, and a caption ON/OFF button L for receiving instructions from the user based on the operation of a mouse (pointing device) I or the like are displayed in addition to the video G or caption text H. Further, a window M that shows the present status, a list of channels, or a list of video recording files (recorded data 204) is displayed, or the caption text can be searched and a list U of search results thereof can be displayed or a sub-window N for preselecting a program can be displayed.

A method implemented with the above-described configuration via an embodiment of the present invention is a broadcasting reception method, and a program for realizing this method is equivalent to a broadcasting reception program. Where the broadcasting reception program is stored in a storage device 80, the storage device 80 serves as a computer-readable recording medium where the broadcasting reception program has been recorded.

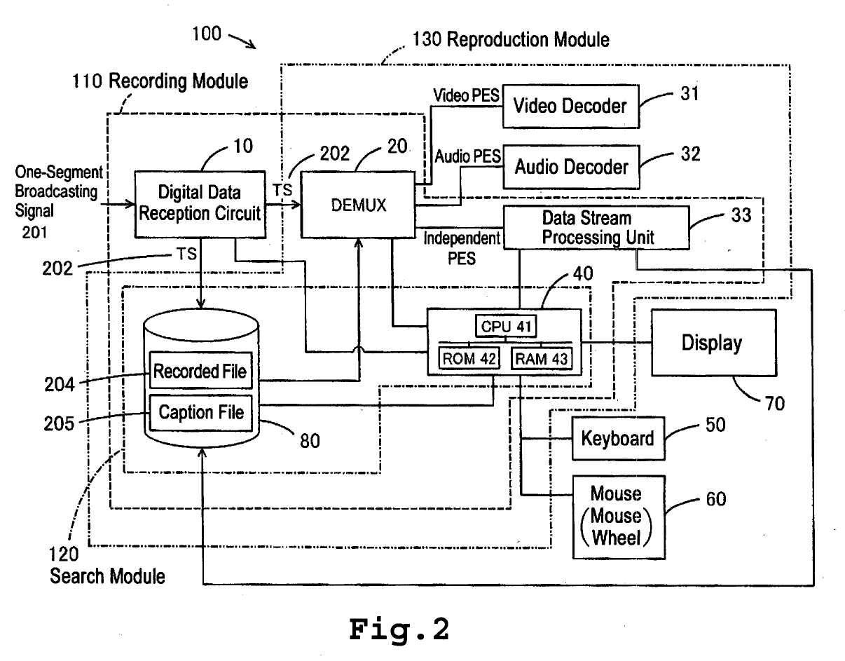

FIG. 2 is a schematic block-diagram illustrating the configuration of the one-segment broadcasting receiver A. As shown in FIG. 2, a digital data reception circuit 10 receives the one-segment broadcasting signal 201 and converts it into the transport stream 202 composed of TS packets. The digital data reception circuit 10 corresponds to a digital broadcasting tuner portion, in particular, a reception circuit of one-segment broadcasting, and is formed in a variety of forms to receive digital contents such as dynamic images, audio, and caption of broadcasting that are sent as the transport stream 202 for the one-segment broadcasting. The present device as a whole is realized as a personal computer 100.

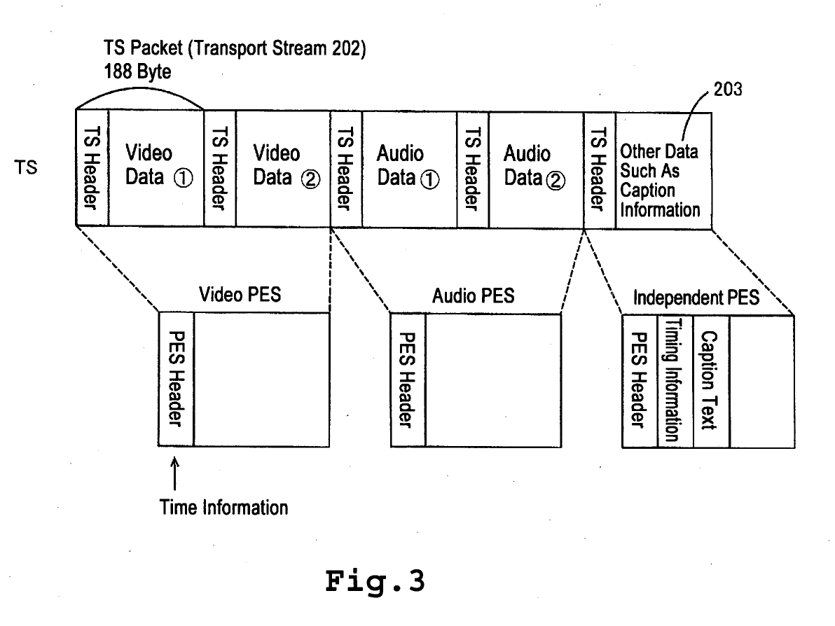

The received transport stream 202 is outputted to a DEMUX (DeMultiplex) circuit 20. As shown in FIG. 3, the transport stream 202 is a series of TS packets composed of 188 bytes, and each TS packet includes a TS header and a payload (data body). The TS header includes various information and has saved therein various kinds of information for generating PES (Packetized Elementary Stream) packets, including the information on data contained in the payload. Accordingly, the DEMUX circuit 20 analyzes the TS header contained in the TS packet as shown in FIG. 3 and separates it into PES packets of respective kinds.

In the example shown in a simple manner in FIG. 3, two video data that will constitute one video PES are written in two leading TS packets, two audio data that will constitute one audio PES are written in the next two TS packets, and one datum including caption information 203 that will constitute an independent PES is written in the very last TS packet. The video PES and audio PES are constituted by two TS packets, and data indicating the correspondence relationship thereof are written in the TS header. This is merely a simple illustrative example, and the number of TS packets constituting one PES packet is actually not limited.

In the case of digital contents of dynamic images based on the MPEG standard, the video PES and audio PES are included therein, and the independent PES of data such as caption information 203 for displaying the text or the like in superposition on (or separately from) the video of the program in data broadcasting is also included therein. The DEMUX circuit 20 demultiplexes the TS packet and extracts the video PES, audio PES, and independent PES. The present embodiment is particularly adapted for the case in which caption is displayed in addition to reproducing video and audio of dynamic images. Thus, the PES packet is inputted as the video PES into a video decoder 31 and converted into a video signal, inputted as the audio PES into an audio decoder 32 and converted into an audio signal, and inputted as the independent PES into a data stream processing unit 33 and converted into a caption signal. The video PES and audio PES also include synchronization information, and the video decoder 31 and audio decoder 32 synchronously reproduce the signals based on the synchronization information. Further, the independent PES also includes time information for synchronizing the caption display with video/audio, in addition to the caption information 203, thereby enabling an accurate synchronous display of video and audio. These synchronization processes can employ well-known techniques. The video decoder 31, audio decoder 32, and data stream processing unit 33 may be also synchronized autonomously, or the synchronization may be performed based on the control by an external controller.

A control circuit 40 has inside thereof a CPU (Central Processing Unit) 41, semiconductor memories 42, 43, a timer circuit, an I/O (input/output) circuit, and the like. The CPU 41 performs the processing of appropriately reading the broadcasting reception program or information of various kinds, for example, from the storage device 80 to a RAM (Random Access Memory) 43 according to the program written in a ROM (Read Only Memory) 42 and then executing the control program, and also controls the operation of the entire one-segment broadcasting receiver A. The control circuit 40 receives the input of various commands from the user via the operation of input devices such as a keyboard 50 or a mouse (pointing device) 60 and performs control of various types by outputting commands to different units located in the personal computer 100, such as the digital data reception circuit 10, DEMUX circuit 20, and data stream processing unit 33. The commands from the user are inputted via a user interface.

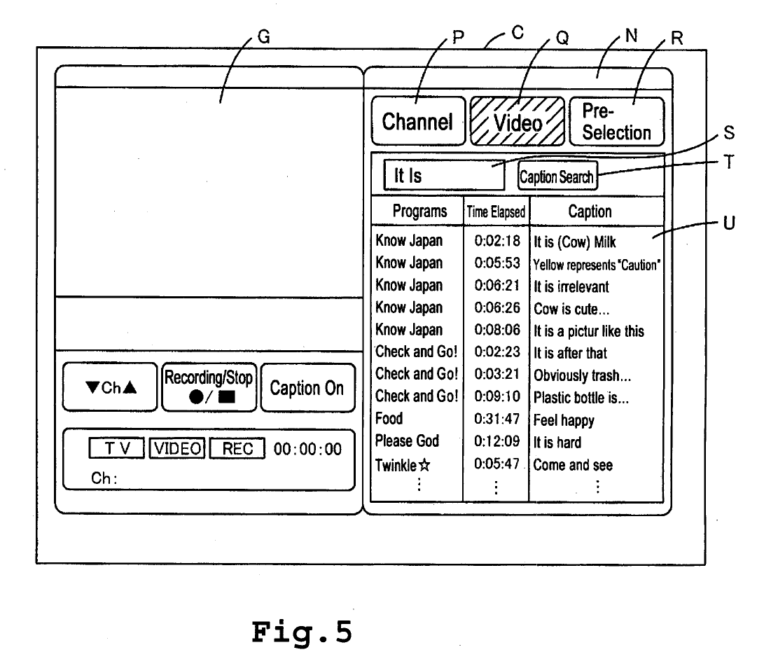

The user interface determines a method by which the personal computer 100 displays information to the user or a method by which the user inputs information. As shown in FIG. 1 and FIG. 5, the user interface displayed on the screen C of the display 70 comprises a channel switching button J for switching the viewing channels of broadcasting, a video recording/stop button K for starting or ending the recording of images of the broadcasting, a caption ON/OFF button L for switching between a mode in which caption is displayed and a mode in which it is not displayed, a window M for displaying the present status, and a sub-window N. The sub-window N is a window for displaying a button P for displaying a list of channels, a video button Q for displaying a list or video recording files (recorded data 204), a button R for preselecting video recording, a text row input window S for inputting a text row when the user searches caption text, a search button T for initiating the search of caption text, and a list of search results U.

More specifically, for example, where the user clicks the mouse 60 on the image recording/stop button K during the reception of broadcasting, the control unit 80 records the transport stream 202 as video recorded data 204 based on the command from the control circuit 40. At the same time, the data stream processing unit 33 extracts the caption information 203 contained in the transport stream 202 corresponding to these video recorded data 204, that is, caption text contained in the independent PES, based on the command from the control circuit 40, and the storage device 80 assigns the elapsed time t since the recording initiation of the video recorded data 204 to the extracted caption text based on the command from the control circuit 40 and then records the caption text as caption data 205. A plurality of types of the video recorded data 204 can be recorded on the storage device 80 and the caption data 205 are recorded for each of a plurality of type of the video recording data 204. A hard disk unit or a semiconductor memory such as a flash memory can be used as the storage device 80.

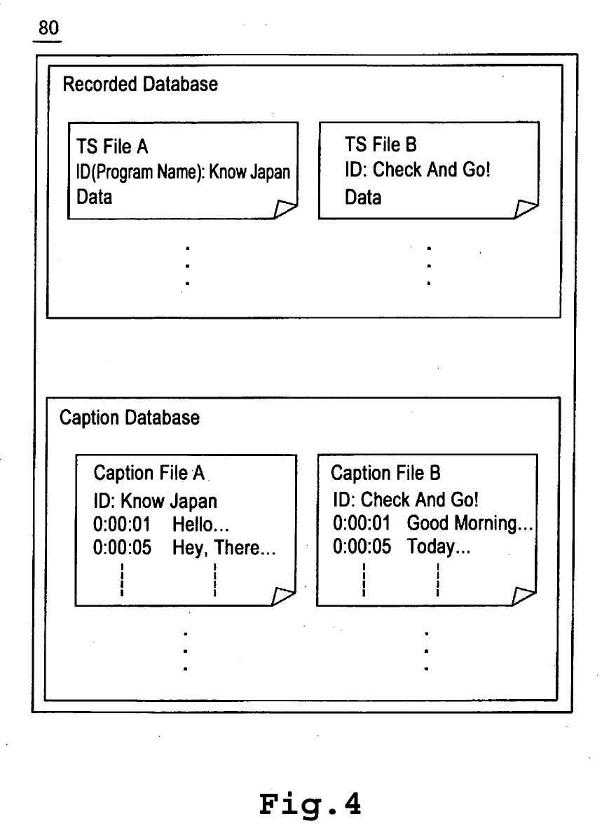

FIG. 4 shows an image of database recorded on the recording device 80. TS files are files of video recorded data 204, and caption files are files of caption data 205. The TS files can be classified by the identification information ID contained in the video recorded data 204, for example, by the program name. The caption files include, for example, the identification information ID of the corresponding video recorded data 204 and have saved therein the caption text corresponding to each elapsed time t.

For example, where the user clicks the mouse 60 on the video button Q, the control circuit 40 displays a list of video recorded data 204 and also the text row input window S and search button T on the subwindow N. Where the user then inputs a text row from the keyboard 50 into the text row input window S and clicks the mouse 60 on the search button T, the control circuit 40 searches the caption text containing the inputted text row from the caption data 205 recorded on the storage device 80, and displays the search results U on the screen C of the display 70.

FIG. 5 shows how a list U of search results is displayed as an example of the aforementioned search results on the subwindow N. In FIG. 5, the displayed list U of search results includes the program name serving as identification information ID of the video recorded data 204 corresponding to the caption text searched from the caption data 205 recorded on the storage device 80, the elapsed time t, and the caption text.

For example, where the user clicks the mouse 60 on the desired caption text (or program name or elapsed time t) from the search results U, thereby alternatively selecting the caption text, the control circuit 40 starts reproducing the corresponding video recorded data 204 from the elapsed time t corresponding to the selected caption text. Thus, by the command from the control circuit 40, the DEMUX circuit 20 demultiplexes the TS packets in the transport stream 202 of the corresponding video recorded data 204 and extracts the video PES, audio PES, and independent PES, and the video decoder 31, audio decoder 32, and data stream processing unit 33 execute reproduction from the elapsed time t based on the video PES, audio PES, and independent PES.

As described hereinabove, the independent PES includes timing information for synchronizing the caption display with video and audio in addition to the caption information 203. In the case where this timing information is used in the process of recording the caption data 205 or performing reproduction during caption search, the corresponding timing information has to be searched from the video recorded data 204, and the reproduction processing of the video recorded data 204 can be delayed for at least this search time. Accordingly, because the bit rate in the broadcasting is fixed (maximum 412 kbps), in the present embodiment, the reproduction start location of the video recorded data 204 is designated with pinpoint accuracy by using the elapsed time t since the recording initiation of the video recorded data 204 in the process of recording the caption data 205 or performing reproduction during caption search.

In the above-described configuration, a recording module (recording unit) 110 is configured by the digital data reception circuit 10, DEMUX circuit 20, data stream processing unit 33, control circuit 40, and storage device 80, this recording module having a recording function of recording the transport stream 202 constituting the one-segment broadcasting signal 201 as video recorded data 204, assigning the elapsed time t since the recording initiation of the video recorded data 204, and then recording the caption information 203 contained in the transport stream 202 corresponding to the video recorded data 204 as the caption data 205. Further, a search module (search unit) 120 is configured by the control circuit 40 and storage device 80, this search module having a search function of searching from the caption data 205 the caption information 203 containing the text row inputted via the user interface that received a command from the user and displaying the search results U on the screen of the personal computer 100. A reproduction module (reproduction unit) 130 is configured by the DEMUX circuit 20, video decoder 31, audio decoder 32, data stream processing unit 33, control unit 40, and storage device 80, this reproduction module having a reproduction function such that when the caption information 203 is alternatively selected from the search results U via the user interface, the reproduction of the corresponding video recorded data 204 is started from the elapsed time t corresponding to the selected caption information.

In the one-segment broadcasting receiver A (personal computer 100) in accordance with the present invention that has the above-described configuration, the caption data 205 in each video recorded data 204 can be saved in the storage device 80 in association with the elapsed time t since the recording initiation of respective video recorded data 204 of each of a plurality of kinds of video recorded data 204. Further, the user can search the desired scene from the video recorded data 204 of a plurality of kinds by using any text row displayed in the caption or can search the scene where this text row has been used. In addition, the user can perform reproduction from the desired scene containing the aforementioned any text row in the corresponding video recorded data 204.

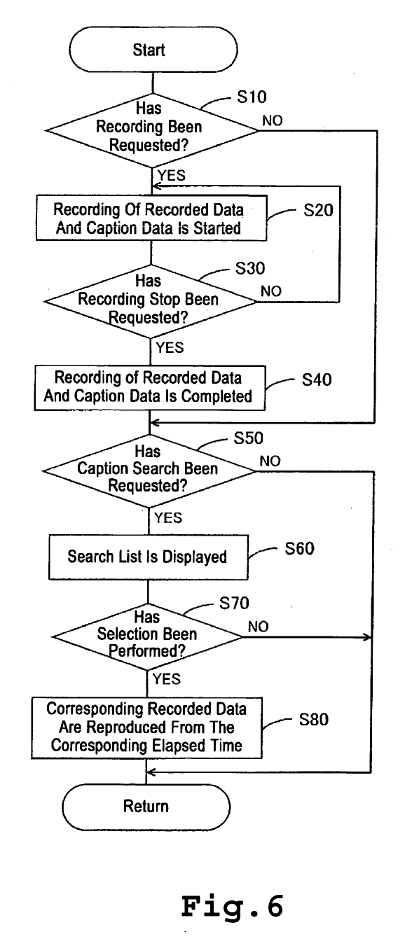

Specific control relating to reproduction of a desired scene from the video recorded data 204 in the personal computer 100 will be explained below. FIG. 6 is a flowchart illustrating a specific control operation for reproducing the desired scene from the video recorded data 204 in the personal computer 100. This control operation is repeatedly executed with a predetermined period.

As shown in FIG. 6, first, in step S10, the user clicks the mouse 60, for example, on the recording/stop button K as the broadcasting is received, thereby determining whether program recording has been requested. If the decision in step S10 is YES, then the corresponding transport stream 202 is recorded as the video recorded data 204 in the storage device 80 in step S20. At the same time, the caption text contained in the transport stream 202 corresponding to the video recorded data 204 is extracted, the elapsed time t since the recording initiation of the video recorded data 204 is assigned to the extracted caption text, and the resultant caption text is recorded as the caption data 205 in the storage device 80.

Then, in step S30, the user clicks the mouse 60, for example, on the recording/stop button K as the broadcasting is recorded, thereby determining whether recording stop has been requested. If the decision in step S30 is NO, then the step S20 is repeatedly executed, and if the decision is YES, then in the step S40 the recording of recorded and caption data in the step S20 is completed. As a result, the TS file and caption file such as shown in FIG. 4 are saved in the storage device 80.

After step S40, or if the decision in step S10 is NO, in step S50, the user clicks the mouse 60, for example, on the video button Q and after the text row input window S or search button T has been displayed in the sub-window N, the user inputs the text row from the keyboard 50 and clicks the mouse 60 on the search button T, thereby determining whether the caption search has been requested.

If the decision of step S50 is NO, then the routine is completed, and if the decision is YES, then in step S60, the caption text including the inputted text row is searched from the caption data 205 recorded on the recording device 80 and, as shown in FIG. 5, a list U of search results is displayed in the sub-window N.

Then, in step S70, the user clicks the mouse 60, for example, on the desired caption text (or program name or elapsed time t) from the list of search results U and determines whether this caption text has been alternatively selected.

If the decision of step S70 is NO, the present routine is completed, but if the decision is YES, then in step S80, the reproduction of corresponding video recorded data 204 is started from the elapsed time t corresponding to the selected caption text.

As described above, in the present embodiment, the caption data 205 in the recorded data 204 can be saved in the recording device 80 in association with the elapsed time t from the recording initiation of the recorded data 204, and the user can search the desired scene in the recorded data by using any text row that has been displayed in the caption, or can search the scene in which this text row has been used. In addition, the user can reproduce the recorded data 204 from the desired scene including the aforementioned text row. Therefore, it is possible to provide a broadcasting receiver A in which convenience for the user is improved when the desired scene is reproduced from the recorded data 204. Further, recorded data 204 of a plurality of kinds can be saved in the recording device 80, the caption data 205 in each recorded data 204 can be saved in the recording device 80 for each of a plurality of kinds of recorded data 204, and the user can search the desired scene from among the recorded data 204 of a plurality of kinds or can search the scene where the text row has been used. In addition, the user performs reproduction from the desired scene containing the aforementioned any text row in the corresponding recorded data 204. Therefore, the convenience for the user can be increased when the desired scene is reproduced from the recorded data 204 of a plurality of kinds.

In the present embodiment, by using the elapsed time t from the recording initiation of recorded data 204, it is possible to designate the reproduction start location with pinpoint accuracy during reproduction of recorded data 204. Therefore, the reproduction of recorded data 204 can be executed with a comparatively high speed when the timing information is used for synchronizing video information and audio information.

Further, with the present embodiment, it is possible to provide a broadcasting reception method and a computer readable recording medium on which a broadcasting reception program has been recorded that demonstrate the same effect as described hereinabove.

The embodiment of the present invention is described hereinabove with reference to the appended drawings, but the present invention can be also employed in other modes thereof.

For example, in the above-described embodiment, as shown by a flowchart in FIG. 6, one control operation is explained in which the control operation (steps S10 to S40) relating to the recording of the recorded data 204 and caption data 205 to the storage device 80 (saving of the TS file and caption file in the storage device 80) and the control operation (steps S50 to S80) relating to caption detection and reproduction of the recorded data are interconnected, but (steps S10 to S40) and (steps S50 to S80) may be independent control operations. In other words, the caption search is executed not only with respect to immediately preceding caption data, but also with respect to earlier caption data 205 that have already been recorded on the recording device 80. When a plurality of kinds of caption data (caption files) 205 are present, the caption search in step S50 is obviously also executed with respect to a plurality of kinds of caption data (caption files) 205 in the flowchart shown in FIG. 6.

Described above is merely one embodiment of the present invention, and the present invention can be implemented with various changes and modifications apparent to those skilled in the art. For example, in addition to the aforementioned terrestrial digital television broadcasting, the terrestrial digital broadcasting in accordance with the present invention can also include radio broadcasting. The terrestrial digital broadcasting may also include broadcasting other than one-segment broadcasting. The broadcasting signals in accordance with the present invention can include not only the terrestrial digital television broadcasting signals, but also radio broadcasting signals. The recorded data in accordance with the present invention can include not only the aforementioned video recorded data, but also audio data.

As described hereinabove, in accordance with the present invention, the caption data in the recorded data can be saved, for example, in a storage device in association with the elapsed time from the recording initiation of the recorded data. Furthermore, the user can search the desired scene in the recorded data by using any text row that has been displayed in the caption or can search the scene in which the text row has been used. Furthermore, the user can reproduce the recorded data form the desired scene including the aforementioned any text row. Therefore, it is possible to provide a broadcasting receiver that makes it possible to increase convenience for the user when the desired scene is reproduced from the recorded data.

Further, with the present invention, by using the elapsed time from the recording initiation of recorded data, it is possible to designate the reproduction start location with pinpoint accuracy during reproduction of the recorded data. Therefore, the reproduction of recorded data can be executed with a comparatively high speed when the timing information is used for synchronizing video information and audio information.

Further, in accordance with the present invention, the caption data in each recorded data can be saved, for example, in the recording device for each of a plurality of kinds of recorded data in association with the elapsed time from the recording initiation of the recorded data, and the user can search the desired scene from among the recorded data of a plurality of kinds by using any text row that has been displayed in the caption, or can search the scene where the text row has been used. In addition, the user performs reproduction from the desired scene containing the aforementioned any text row in the corresponding recorded data. Therefore, the convenience for the user can be increased when the desired scene is reproduced from the recorded data of a plurality of kinds.

Further, with the present embodiment, it is possible to provide a broadcasting reception method and a computer readable recording medium on which a broadcasting reception program has been recorded that demonstrate the same effect as described hereinabove.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

In addition, reference to “first,” “second,” “third,” and etc. members throughout the disclosure (and in particular, claims) is not used to show a serial or numerical limitation but instead is used to distinguish or identify the various members of the group.

What is claimed is:

1. A broadcasting receiver that receives broadcasting signals in terrestrial digital broadcasting and displays terrestrial digital broadcasting on a screen of a personal computer, the broadcasting receiver comprising:
a recording unit that records a transport stream comprising the broadcasting signals as recorded data, assigns an elapsed time since recording initiation of the recorded data, and then records caption information contained in the transport stream corresponding to the recorded data as caption data;
a search unit that searches, from the caption data, the caption information including a text row inputted via a user interface that receives a command from a user, and displays search results on the screen of the personal computer; and
a reproduction unit that, when the caption information is alternatively selected from the search results via the user interface, starts reproducing the recorded data from the elapsed time corresponding to the selected caption information.

2. The broadcasting receiver according to claim 1, wherein the terrestrial digital broadcasting is terrestrial digital television broadcasting.

3. The broadcasting receiver according to claim 1, wherein the terrestrial digital broadcasting is one-segment broadcasting, and the broadcasting signal is a one-segment broadcasting signal.

4. The broadcasting receiver according to claim 1, wherein
the recording unit can record a plurality of types of recorded data and records the caption data for each of the plurality of types of recorded data;
the search unit displays identification information contained in the recorded data corresponding to the caption information searched from the caption data, the elapsed time, and the caption information, as the search results; and
the reproduction unit reproduces the recorded data selected from the search results from the elapsed time.

5. A broadcasting reception method for receiving broadcasting signals in terrestrial digital broadcasting and displaying terrestrial digital broadcasting on a screen of a personal computer, the method comprising:
recording a transport stream comprising the broadcasting signals as recorded data;
assigning an elapsed time since recording initiation of the recorded data;
recording caption information contained in the transport stream corresponding to the recorded data as caption data;
searching the caption information including a text row inputted via a user interface that receives a command from a user from the caption data;
displaying search results on the screen of the personal computer; and
initiating reproduction of the recorded data from the elapsed time corresponding to the selected caption information when the caption information is alternatively selected from the search results via the user interface.

6. A computer readable recording medium having recorded therein a broadcasting reception program that causes a personal computer to execute a function of receiving broadcasting signals in terrestrial digital broadcasting and displaying terrestrial digital broadcasting on a screen of the personal computer, the personal computer caused to execute:
a recording function that records a transport stream comprising the broadcasting signals as recorded data, assigns an elapsed time since recording initiation of the recorded data, and then records caption information contained in the transport stream corresponding to the recorded data as caption data;
a search function that searches, from the caption data, the caption information including a text row inputted via a user interface that receives a command from a user, and displays search results on the screen of the personal computer; and
a reproduction function that, when the caption information is alternatively selected from the search results via the user interface, starts reproducing the recorded data from the elapsed time corresponding to the selected caption information.
